(19) United States
(12) Patent Application Publication
(10) Pub. No.: US 2012/0298908 A1
(43) Pub. Date: Nov. 29, 2012

(54) HEXAGONAL FERRITE MAGNETIC POWDER AND MAGNETIC RECORDING MEDIUM USING THE SAME

(75) Inventors: Toshihiko Ueyama, Okayama (JP); Kenji Masada, Okayama (JP)

(73) Assignee: DOWA ELECTRONICS MATERIALS CO., LTD., Tokyo (JP)

(21) Appl. No.: 13/576,073

(22) PCT Filed: Mar. 29, 2011
(86) PCT No.: PCT/JP2011/057737

§ 371 Date: Jul. 30, 2012

(30) Foreign Application Priority Data
Mar. 31, 2010 (JP) 2010-084309

(51) Int. Cl. H01F 1/00

(52) U.S. Cl. 252/62.51 R

(57) ABSTRACT

A hexagonal ferrite magnetic powder with a reduced amount of contaminants such as organic materials and a magnetic recording medium using the same are provided. The magnetic recording medium is formed using such a hexagonal ferrite magnetic powder that, when 0.10 mol/L nitric acid is added in an amount that changes the pH of 100 mL of a pH 11 potassium hydroxide solution (a blank solution) to 5 to a solution prepared by adding 0.05 g of the powder to 100 mL of the pH 11 potassium hydroxide solution, the pH of the resultant solution is 5 or higher.

### FIELD

The present invention relates to a hexagonal ferrite magnetic powder for magnetic recording mediums and to a coating-type magnetic recording medium using the powder.

### BACKGROUND

At present, metal magnetic powders are mainly used as magnetic materials for coating-type high-density magnetic recording mediums. Metal magnetic powders have been reduced in size and increased in magnetic force to achieve low noise and is high power. Such metal magnetic powders are composed mainly of metals, and therefore it is necessary to avoid deterioration of magnetic force due to oxidation over time. Generally, an oxide film is formed on the surface of a magnetic powder to prevent oxidation. However, as the size of particles decreases, the ratio of the volume of the oxide film to the volume of the particles increases. Therefore, the ratio of the metal portion responsible for magnetic force decreases, and this results in an inevitable reduction in the magnetic force of the powder itself. More specifically, conventional means used with the aim of increasing magnetic force while the trade-off between improvement in magnetic force and prevention of oxidation is maintained is approaching its limits.

Therefore, it is contemplated that materials other than metal magnetic powders are used as magnetic powders for next generation high-density magnetic recording. A representative example of such materials is a magnetic powder of hexagonal ferrite. The hexagonal ferrite itself has an oxide structure, so that the problem of aging deterioration of magnetic force due to oxidation can be avoided. Although the magnetization of hexagonal ferrite is lower than that of metal magnetic powders, a larger coercive force can be obtained by controlling the crystalline anisotropy of the hexagonal ferrite. Therefore, such hexagonal ferrite is expected to be used as a magnetic is powder for high-density magnetic recording. Particularly, with recently developed magnetic heads for magnetic recording, recording and reproduction can be performed even when recording mediums do not have very high magnetization. Therefore, ferrite powders with relatively low magnetization can also be used as materials for recoding mediums.

However, as pointed out in Patent Literature 1, since the particles of a hexagonal ferrite magnetic powder are single crystals, their surfaces are smooth, and a problem arises in that the dispersibility of the particles is lower than that of conventional polycrystalline magnetic powders. To solve this problem, Patent Literature 1 proposes that the dispersibility of a magnetic powder is improved by coating its surface with an actinoid compound to increase the number of basic sites on the surface.

Patent Literature 2 proposes an attempt to improve the dispersibility of particles by reforming the surfaces of the particles so that the surfaces exhibit hydrophobicity.

### CITATION LIST

### Patent Literature

Patent Literature 1: Japanese Patent Application Laid-Open No. 2002-313619
Patent Literature 2: Japanese Patent Application Laid-Open No. 2009-088293

### SUMMARY

### Technical Problem

In the attempts in the technologies disclosed in Patent Literatures 1 and 2, the surfaces of magnetic powders are coated or reformed, i.e., the surfaces of ferrite-based magnetic powders are coated with another layer to modify their surface properties. The addition of the step of forming a new layer on the surface of a magnetic powder, as described above, causes many unexpected problems during long term storage and use, such as a reaction with a binder after a recording medium is formed and an unexpected reaction with a material in external contact with the powder during use. In addition, it is not preferable in terms of productivity and yield.

Next, consideration will be given to methods of producing hexagonal ferrite. In any method using a glass crystallization method that is currently considered to give a preferable magnetic powder, the step of removing glass using acetic acid is always performed in the final stage to collect the ferrite magnetic powder. With such a method, a large amount of components originating from acetic acid may remain present on the surface of the hexagonal ferrite. Particularly, the is presence of the components originating from acetic acid on the surface may cause significant influence on deterioration of dispersibility. However, the influence of substances adhering to the surface of hexagonal ferrite during the production process has not been extensively studied.

The present inventors have made extensive studies with attention paid to the influence of adhering substances and have found that control of components adhering during a production process (hereinafter referred to as “contaminants”), instead of coating the surface of hexagonal ferrite with another material, is useful for improvement in dispersibility.

To solve the foregoing problems, it is an object of the present invention to provide a hexagonal ferrite magnetic powder containing a reduced amount of contaminants such as organic materials and a magnetic recording medium using the magnetic powder.

### Solution to Problem

The foregoing problems can be solved by using a powder having the following properties as a magnetic powder contained in a magnetic recording medium.

The powder may be a hexagonal ferrite magnetic powder, wherein, when 0.10 mol/L nitric acid is added in an amount that changes the pH of 100 mL of a pH 11 potassium hydroxide solution used as a blank solution to 5 to a solution prepared by adding 0.05 g of the hexagonal ferrite magnetic powder to 100 mL of the blank solution, the value of pH of the resultant solution is 5 or higher.

The powder may be a hexagonal ferrite magnetic powder wherein, when 0.10 mol/L nitric acid is added in an amount that changes the pH of 100 mL of a pH 11 potassium hydroxide solution used as a blank solution to 5 to a solution prepared by adding 0.05 g of the hexagonal ferrite magnetic powder to 100 mL of the blank solution, the computed amount of protons (H⁺) released is equal to or larger than 0.

In the above hexagonal ferrite magnetic powders, the isoacidic point computed using 0.05 g of the hexagonal ferrite magnetic powder may be pH=5 or higher. The isoacidic point is the point at which the amount of protons (H⁺) released from the particles is the same as the amount of protons (H⁺) adsorbed on the particles in a balanced manner and can be measured using, for example, a streaming potential titrator.

Any of the above hexagonal ferrite magnetic powders may have a property that the difference between the isoacidic point computed using 0.05 g of the hexagonal ferrite magnetic powder and the isoacidic point computed using 0.5 g of the hexagonal ferrite magnetic powder is less than ±1.5.

The powder may be a hexagonal ferrite magnetic powder having any of the above-described properties and including particles having a powder pH of 7.0 or higher that is computed by a boiling method described in JIS standard K-5101-17-1:2004.

The powder may be a hexagonal ferrite magnetic powder having any of the above-described properties and having an average plate diameter of 5 to 50 nm and a specific surface area of 50 m²/g or higher as measured by a BET method.

### Advantageous Effects of Invention

The present invention can provide a magnetic powder that is expected to exhibit high dispersibility in a binder without coating the surface of the powder with another material. Therefore, a high-density magnetic recording medium having high magnetic properties can be provided.

### BRIEF DESCRIPTION OF DRAWINGS

FIG. 1 is a schematic diagram of a measurement device used to evaluate surface properties.

FIG. 2 is a graph showing a change in number density of protons released/absorbed from/by particles to/from a reference solution (a solution containing no powder), the change being computed when 0.05 g of a sample powder is added to the reference solution.

FIG. 3 is a graph showing the behavior of pH observed when 0.10 mol/L nitric acid is added to an aqueous potassium hydroxide solution with a pH of 11.

FIG. 4 is an enlarged graph of a portion of FIG. 3 in which the range of the amount added of nitric acid is 0.8 to 1.2 mL.

FIG. 5 is a graph showing the correlation between the isoacidic point (0.05 g) and the SQx of a single-layer medium.

FIG. 6 is a graph showing the correlation between powder pH and the SQx of a single-layer medium.

FIG. 7 is a graph showing the correlation between (powder pH-isoacidic point (0.05 g)) and the SQx of a single-layer medium.

FIG. 8 is a graph showing the correlation between the isoacidic point (0.05 g) and the SFDx of a single-layer medium.

FIG. 9 is a graph showing the correlation between powder pH and the SFDx of a single-layer medium.

FIG. 10 is a graph showing the correlation between (powder pH-isoacidic point (0.05 g)) and the SFDx of a single-layer medium.

### DESCRIPTION OF EMBODIMENTS

The present inventors have found that when a hexagonal ferrite magnetic powder of fine particles having a specific composition is produced under specific synthesis conditions and production conditions, the magnetic powder described above can be obtained. Thus, the present invention has been completed. More specifically, the magnetic powder has the properties described below. In the present description, it is appreciated that the magnetic powder (or simply “powder”) is composed of magnetic particles (or simply “particles”).

Whether or not the hexagonal ferrites according to the present invention, particularly hexagonal barium ferrite, have their specific forms can be determined by X-ray diffraction pattern comparison. One specific method is qualitative analysis, and the JCPDS card chart of hexagonal barium ferrite is 27-1029.

### <Structure of Particles>

The particles according to the present invention contain iron and an alkaline-earth metal (A) as main components and further contain divalent and tetravalent additive elements (M₁, M₂) used to control coercive force and bismuth being an additive element used to control the shape of the particles. The particles further contain another additive element such as a group 5 metal, for example, Nb, or a rare-earth element. Particularly, the addition of a rare-earth element is preferred because a reduction in the size of particles is facilitated, so that a reduction in volume of small particles (an increase in specific surface area), which is one of the objects described above, can be achieved relatively easily.

Particularly, when a rare-earth element is used, Nd, Sm, Y, Er, Ho, etc. are preferably selected. Of these, Nd, Sm, and Y are selected more preferably. The amount added of the rare-earth element is 0.2 to 1.0 at. % based on the amount of iron. More specifically, in an expression (Ba, Sr, Ca, Pb)aFebBicM₁dM₂eRf, f/b is 0.002 to 0.01. The expression “(Ba, Sr, Ca, Pb)aFebBicM₁dM₂eRf” means that the molar ratio of (Ba, Sr, Ca, Pb), Fe, Bi, M₁, M₂, and R is a:b:c:d:e:f.

Generally, rare-earth elements are expensive, and the use of a rare-earth element is not preferable from an industrial point of view because the addition of such an element in an amount more than necessary causes an increase in cost. However, when the amount added is reduced, the effects of the addition are not obtained, which is not preferred. Therefore, all or part of the rare-earth element may be substituted with an element that can maintain the original properties after substitution, more specifically with a group 5 element. Particularly, a group 5 element that easily forms an oxide is preferably used. The amount added of such an element may be the same as the amount added of the rare-earth component described above. The use of such an amount provides the effect of isolating adjacent ferrite particles produced and can therefore improve magnetic properties.

If a production method that does not use the above-described components is used, small particles may be obtained in some cases. However, such particles are easily sintered to each other, and the distribution of the formed particles may be significantly poor. This results in a reduction in production stability. In addition, when a coating is formed, a large number of particles aggregate into clusters, and significant irregularities are formed on the surface of the film of the coating. Therefore, such particles are not preferred.

“Particles with high dispersibility” in the present invention are particles that can maintain their form of primary particles when used for a coating and cause less aggregation of particles. A specific example of such particles is particles that form aggregated clusters having an aggregate diameter of 2.0 μm or lower and preferably 1.5 μm or lower when, for example, a coating described in “Evaluation of single-layer magnetic tape” in the present specification is formed. The aggregate diameter is measured using a grind gauge method described in “JISK-5600-2-5: 1999, General test methods for coatings, Part 2: Properties-stability of coatings, Section 5: Dispersibility.” To determine the aggregate diameter in more detail, grooves with a maximum depth of 15 μm are used.

The addition of bismuth allows ferritization temperature to be reduced and therefore can reduce the occurrence of sintering of particles, and this can contribute to a reduction in size of the particles. The plate thickness of the particles can be controlled by controlling the amount added of bismuth. Therefore, if the amount added of bismuth is too high, particles with a large plate diameter may be formed, and this may results in large particles.

According to the studies by the inventors, the amount added of bismuth that can provide the balance therebetween is less than 10% in molar ratio based on the amount of iron and preferably less than 5% (of course, the amount of bismuth is higher than 0% because it is an essential ingredient). In other words, in the expression (Ba, Sr, Ca, Pb)aFebBicM₁dM₂eRf, c/b is less than 0.1 and preferably less than 0.05.

The particles of the present invention have the following physical properties. The average particle diameter (which corresponds to the average plate diameter when the particles have a plate-like shape and to the average diameter when the particles are spherical) is 10 to 30 nm and preferably 10 to 25 nm. When the average particle diameter is larger than 30 nm, noise in a recording medium formed using the particles is high, and such large particles are not suitable for high density recording. Particles smaller than 10 nm are not preferred because of their low thermal stability.

Determination of particle shape and measurement of particle volume are performed as follows. When the shape of the particles is unchanged even when the stage of a TEM is tilted, i.e., the shape of the particles when the stage is not tilted is circular or a shape close to a circular shape and the observed shape is unchanged even when the stage is tilted, these particles are considered to be spherical. However, when the shape of the particles is changed when the stage is tilted, i.e., only their thickness is changed with the diameter being unchanged, for example, the shape becomes rectangular, the particles are considered to have a plate-like shape.

The average particle volume is computed on the basis of the above described determination. When the particles are spherical, the particle volume is computed using the method of computing the volume of a sphere ((4/3)×π×(particle diameter/2)³. When the particles have a plate-like shape, the particle volume is computed by multiplying the surface area of the plate face of the particle by its thickness (the thickness is a minimum value when the particle is observed while the stage is tilted).

The particle volume computed by any of the above methods is 100 to 2,500 nm³ and preferably 500 to 2,500 nm³. Particles smaller than the above range have low thermal stability and are difficult to be used for a magnetic recording application. Excessively large particles are not preferred because their diameter is large and such particle may cause noise.

The specific surface area of the particles computed by the BET single-point method is 50 to 120 m²/g, preferably 55 to 115 m²/g, and more preferably 60 to 110 m²/g. Particles having a specific surface area lower than the lower limit are not preferred because the particles may aggregate or coagulate and therefore may not be easily dispersed. This may cause irregularities on a coated medium, resulting in deterioration of the properties of the medium. An excessively high specific surface area is also not preferred because the presence of super para particles with no magnetization is suspected and the properties of a medium in general deteriorate.

The TAP density of the particles is 0.8 to 2.0 g/cc, preferably 1.0 to 1.8 g/cc, and more preferably 1.0 to 1.5 g/cc. In the above range, the packing density of the particles in a recording medium produced can be high. In addition, since the amount of fine powder is small, a magnetic recording medium having improved magnetic properties can be formed, and the surface smoothness can be improved.

The powder pH of the particles that is computed by the boiling method stipulated in JIS is 4 to 9 and more preferably 5 to 9. The value of the powder pH varies depending on the composition or the surface treatment performed on the magnetic powder. Therefore, powders having the same composition do not always have the same powder pH value. By adjusting the powder pH within the above range, an influence on components seeping from the particles and on other components contained in a magnetic recording medium can be suppressed, and the storage stability of the medium can thereby be improved. When the powder pH is 4 or lower in the acidic range, the amount of components that react with a binder etc. and seep from the magnetic particles increases. In addition, the powder pH of 4 or lower causes corrosion of other constituent components. Strongly basic particles are not preferred because constituent components susceptible to alkalis are eroded.

### <Synthesis of Particles>

The magnetic powder having the above-described properties can be produced, for example, by the following method. In the present specification, an example using a so-called glass crystallization method is described. The amounts of materials used to form the magnetic powder can be applied to other methods.

First, a glass base material, iron and an alkaline-earth metal used as main constituent raw materials, and additives such as Co, Ti, Zn, Nb, and Bi are mixed. The ratio of the amounts added of these main constituent components is set to the above-described target ratio based on the amount of iron. However, because of the reason described later, the molar amount of the rare-earth element fed is equal to or lower than the molar amount of iron fed and is larger than the estimated amount contained in the final product.

More specifically, the molar amount of the rare-earth to element or the group 5 metal is equal to or less than the molar amount of iron fed, preferably 15 mol % or less, and more preferably in the range of 1.5 to 12.5 mol %. When the amount added is within the above range, the rare-earth element or the group 5 metal serves as an anti-sintering agent that prevents sintering of particles during heat treatment performed after glass is formed. Therefore, when hexagonal ferrite is formed, the ferrite particles are separated from each other, and small volume particles as in the present invention can thereby be formed. Preferably, each of the main constituent raw materials and the additives is in a salt form. More specifically, any of nitrates, sulfates, acetates, oxides, etc. may be selected, and oxides are suitable.

No limitation is imposed on the method of mixing, so long as the raw materials and the glass base material are uniformly mixed. Preferably, a dry method is used.

The mixture is melted in an electric furnace. The melting temperature used is 1,000 to 1,600° C., preferably 1,100 to 1,500° C., and more preferably 1,150 to 1,450° C. The melting may be performed under stirring. It is sufficient that the glass, ferrite and additive components are uniformly melted during the melting process. Therefore, the melting time is 6 hours or shorter, preferably 4 hours or shorter, and more preferably 2 hours or shorter.

A boron compound, a silicon compound, and, if necessary, an alkali metal oxide such as sodium oxide or potassium oxide may be added and melted in an amount that does not affect is magnetic properties. The amount added of such compounds is at most 10% by mass or lower based on the total amount, preferably 5% by mass or lower, and more preferably 2% by mass or lower.

The obtained molten mixture is quenched to form glass. No particular limitation is imposed on the quenching method used. However, the double-roller method, the water atomizing method, and the gas atomizing method, which have fast quenching rate, can be preferably used.

The obtained glass may be pulverized. Any well-known pulverization method may be used. For example, pulverization using a ball mill may be performed, but the method used may be appropriately changed according to the scale of pulverization. Then remaining coarse particles produced during pulverization are removed using a sieve. This is preferable because a magnetic powder having uniform magnetic properties can be obtained.

The thus-obtained pulverized product of the glass is subjected to heat treatment to precipitate ferrite. The heat treatment is performed at a temperature that allows ferritization, and the temperature is 450° C. or higher and 900° C. or lower, preferably 500° C. or higher and 850° C. or lower, and is more preferably 550° C. or higher and 700° C. or lower. The heat treatment may be so-called single-stage heating at a single temperature or so-called multi-stage treatment in which the heating is performed in several stages at different treatment temperatures. The time of the heat treatment performed is 30 minutes or longer and preferably 1 hour or longer.

Next, the glass component is removed from the obtained ferrite-containing glass. In this case, diluted acetic acid diluted to about 10% by mass is preferably used, and the treatment temperature is preferably 50° C. or higher. It is sufficient that the glass can be removed. Therefore, the acetic acid may be boiled if necessary and may be stirred to achieve uniform removal. The above washing process allows most of the rare earth remaining in the glass including the ferrite formed therein to be removed.

The obtained ferrite magnetic powder is washed to remove acetic acid etc. adhering to the surface of the ferrite magnetic powder. The washing may be performed using pure water, to or the pure water may be boiled to remove the adhering components. If necessary, ammonia water, an aqueous sodium hydroxide solution, an aqueous potassium hydroxide solution, etc. may be preferably used for washing to neutralize the acetic acid adhering during previous washing. When an aqueous sodium hydroxide solution is used, the concentration thereof is 0.01 to 1.5 mol/L, preferably 0.05 to 1.2 mol/L, and more preferably 0.1 to 1.0 mol/L. A low concentration is not preferred because the effect of washing is low. A high concentration is also not preferred because the effect of washing is saturated and the risk of intrusion of impurities increases.

Then pure water is used as a washing solution, and washing is performed sufficiently until the conductivity of the filtrate becomes 1 mS/m or lower and preferably 0.8 mS/m or lower. The particles often have an aggregate shape, and acetic acid and reaction residues may present between the particles. Therefore, it is preferable to perform removal and washing steps using ultrasonic waves to remove and wash out the glass. In this manner, the amount of remaining impurities, particularly the rare earth element, can be reduced to less than 15% of the total amount added of such components. The non-magnetic components can thereby be removed, and this can contribute to the improvement in the magnetic properties of the particles.

The obtained ferrite after the washing treatment is subjected to moisture removal treatment under the conditions of 100° C. or higher in air to obtain a dry powder. Then is moisture may be allowed to adhere to the surface of the dry magnetic powder in an amount of about 0.5 to about 5.0% by mass in a humid environment of about 80% RH.

### <Evaluation of Magnetic Powder>

The physical properties of the obtained magnetic powder were evaluated by the following methods.

### <Form of Particles>

The average plate diameter or average particle diameter and average plate-shape ratio of the particles were determined using a transmission electron microscope (type JEM-100CXMark-II, a product of JEOL Ltd.). More specifically, a photograph of a bright-field image of the magnetic powder at an acceleration voltage of 100 kV was taken. About 300 particles were used for the measurement of the average plate diameter and the average particle diameter, and about 100 particles were used for the measurement of the plate-shape ratio.

### <Composition of Particles>

The obtained magnetic powder, i.e., the final magnetic powder, was evaluated using the following method. The quantitative analysis of iron was performed on a dissolution sample using a Hiranuma automatic titrator (type CONTIME-980) manufactured by Hiranuma Sangyo Corporation). The quantitative is analysis of the other components was performed on a solution of the powder using an inductively coupled plasma spectrometer ICP (IRIS/AP) manufactured by Nippon Jarrell-Ash Co. Ltd.

### <Specific Surface Area of Particles>

The specific surface area of the particles was measured by the BET single-point method, and 4-Sorb US manufactured by Yuasa Ionics Co., Ltd. is used as the measurement device.

### <Evaluation of Magnetic Properties of Powder>

A plastic container (φ6 mm) is packed with a magnetic powder, and its coercive force Hc (Oe, kA/m), saturation magnetization as (Am²/kg), squareness ratio SQ, and BSFD of the powder (the SFD value in a bulk state) were measured in an external magnetic field of 795.8 kA/m (10 kOe) using a VSM apparatus (VSM-7P, product of TOEI INDUSTRY Co., Ltd.).

### <Evaluation of Single-Layer Magnetic Tape>

0.35 g of the obtained magnetic powder (the final magnetic powder product) was weighed, placed in a pot (inner diameter: 45 mm, depth: 13 mm), and left to stand for 10 minutes with the lid of the pot being opened. Then 0.7 mL of a vehicle (a mixed solution of vinyl chloride-based resin MR-555 (a product of ZEON CORPORATION) (20 percent by mass), Vylon® UR-8200 (a product of TOYOBO Co., Ltd.) (30 percent by mass), cyclohexanone (50 percent by mass), acetyl acetone (0.3 percent by mass), and n-butyl stearate (0.3 percent by mass)) was added using a micropipette. Immediately after the addition, 30 g of steel balls (2φ) and 10 nylon balls (8φ) were added to the pot, and the mixture was left to stand for 10 minutes with the lid being closed.

Then the pot was placed in a centrifugal ball mill (FRITSH P-6). Its rotation speed was gradually increased and adjusted to 600 rpm, and dispersion was performed for 60 minutes. Then the centrifugal ball mill was stopped, and the pot was removed therefrom. Next, 1.8 mL of an adjustment solution prepared in advance by mixing methyl ethyl ketone and toluene (1:1) was added using a micropipette. Then the pot was again placed in the centrifugal ball mill, and dispersion was performed at 600 rpm for 5 minutes to produce a magnetic coating.

Next, the lid of the pot was opened, and the nylon balls were removed. The magnetic coating together with the steel balls was put into an applicator (550 μm) and applied to a base film (polyethylene film 15C-B500, a product of TORAY INDUSTRIES Inc., thickness: 15 μm). Immediately thereafter, the film was placed at the center of the coil of an orientation apparatus of 5.5 kG to perform orientation treatment in a magnetic field and then dried to produce a magnetic tape. The thickness of the coating after drying was 3 μm. In this case, to examine the effects of the magnetic powder more clearly, no non-magnetic layer was provided, and the tape including a single magnetic layer was produced. No calender treatment was performed.

The magnetization of the thus-produced magnetic tape used as a medium was measured using a VSM apparatus (VSM-7P) manufactured by TOEI INDUSTRY Co., Ltd. to determine coercive force Hcx (Oe, kA/m), the distribution SFDx of coercive force in a direction parallel to the surface of the magnetic layer, maximum energy product BHmax, squareness ratio SQx in the direction parallel to the surface of the magnetic layer, squareness ratio SQz in a direction perpendicular to the surface of the magnetic layer, and orientation ratio OR.

### <Computation of Powder pH of Particles>

The powder pH of the particles is measured using a method described in JIS standard K-5101-17-1: 2004 (Pigment test methods, Part 17: pH value, Section 1: Boiling extraction method). The outline of the method is as follows.

A 10% suspension of the test powder is prepared in a glass container using pure water from which carbonic acid gas has been removed. Then the container is heated for about 5 minutes with its lid being opened to boil the suspension. After the boiling state is reached, the boiling is continued for 5 minutes. Then the lid is closed, and the container is allowed to cool to room temperature. Water is added in an amount corresponding to the amount reduced during boiling. The resultant suspension is shaken for 1 minute and then allowed to stand for 5 minutes, and the pH of the suspension is measured to obtain the value of the powder pH.

### <Computation of Amount of Adsorption of Stearic Acid on Particles>

The amount of adsorption of stearic acid was computed as follows. In a glove box inside of which air had been replaced with nitrogen, 2.0 g of a sample obtained by pulverizing a magnetic powder obtained in an Example into 30 mesh was added to 15.0 g of a methyl ethyl ketone solution containing 2% by mass of stearic acid dissolved therein. Then the sample was coagulated from below using a permanent magnet. 10 g of the supernatant was separated, placed on a hot plate, and heated at 90° C. for 3 hours. Then the weight of the residue was measured, and the amount of adsorbed stearic acid was computed using A=1000×B×(C/100)×[1−E/{(C/100)×D}]/F. Here, A is the amount of adsorbed stearic acid (mg/g), B is the total weight (g) of the solution (15.0 g in this case), C is the concentration (percent by mass) of the stearic acid in the solution (2 percent by mass in this case), D is the weight (g) of the supernatant (10 g in this case), E is the weight (g) of the residue after heating at 90° C. for 3 hours, and F is the weight (g) of the sample (2 g in this case). In the above formula, B×(C/100) represents the initial weight (g) of the stearic acid in the solution, and [1−E/{(C/100)×D}] represents the ratio of the stearic acid remaining in the supernatant.

### <Evaluation of Surface Properties of Particles>

0.05 g of a ferrite powder pulverized into 500 mesh was added to 100 mL of a pH 11 potassium hydroxide solution containing 0.1 mol/L of potassium nitrate. Then a 0.01 mol/L aqueous nitric acid solution was added to the resultant solution at a rate of 0.02 mL/min to measure the change in the pH of the magnetic powder sample solution over time, i.e., the change in the pH of the sample solution versus the amount of the aqueous nitric acid solution. Since the aqueous potassium hydroxide solution or a solution alternative thereto has the to ability to absorb carbon dioxide in the air, it is not preferable to use a solution stored for several days after preparation.

The change in pH by the addition of the aqueous nitric is acid solution can be measured using, for example, a streaming potential automatic titrator (streaming potential automatic titrator, type AT-510Win/PCD-500 manufactured by Kyoto Electronics Manufacturing Co., Ltd.). Since it is preferable to perform the measurement with the dispersibility of the test sample being maintained, the measurement of pH as performed while the solution was stirred using a magnetic stirrer.

The same aqueous nitric acid solution as that used above was added to a blank solution containing no magnetic powder, which was the same aqueous potassium hydroxide solution as that used above, to measure the change in the pH of the blank solution with respect to the amount added of the nitric acid in advance. The measured change in the pH was used as the baseline of the change in the pH of the magnetic powder solution versus the amount added of the nitric acid.

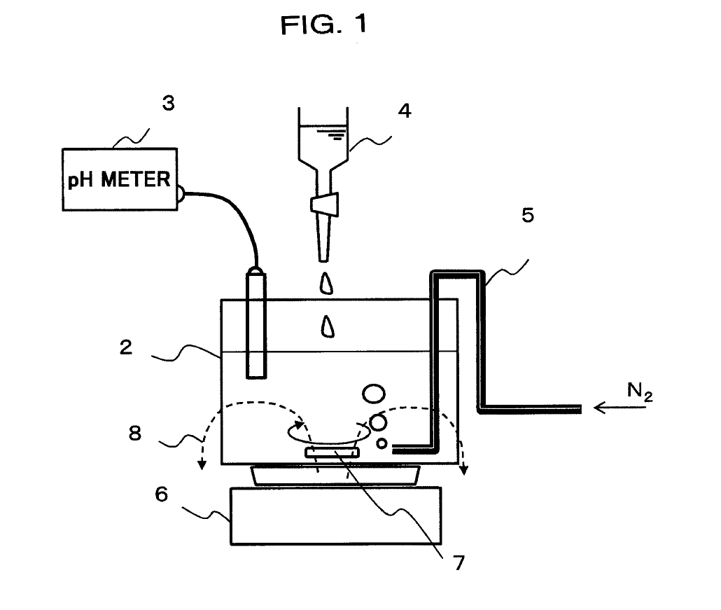

FIG. 1 shows the configuration diagram of the streaming potential automatic titrator 1. The streaming potential automatic titrator 1 includes a tank 2 for storing the potassium hydroxide solution, an electrometer (pH meter) 3 for measuring pH, and a titrator 4 for the aqueous nitric acid solution. An introduction tube 5 for nitrogen gas may be disposed in the tank 2 to prevent a change in pH due to absorption of carbon in the air. The solution in the tank 2 is stirred using a magnetic stirrer 6 and a stirring chip 7. The magnetic stirrer 6 generates an alternating magnetic field 8 to rotate the stirring chip 7. This titrator 4 and the electrometer (pH meter) 3 are controlled by a not-shown controller, and the titer and the pH value are successively recorded.

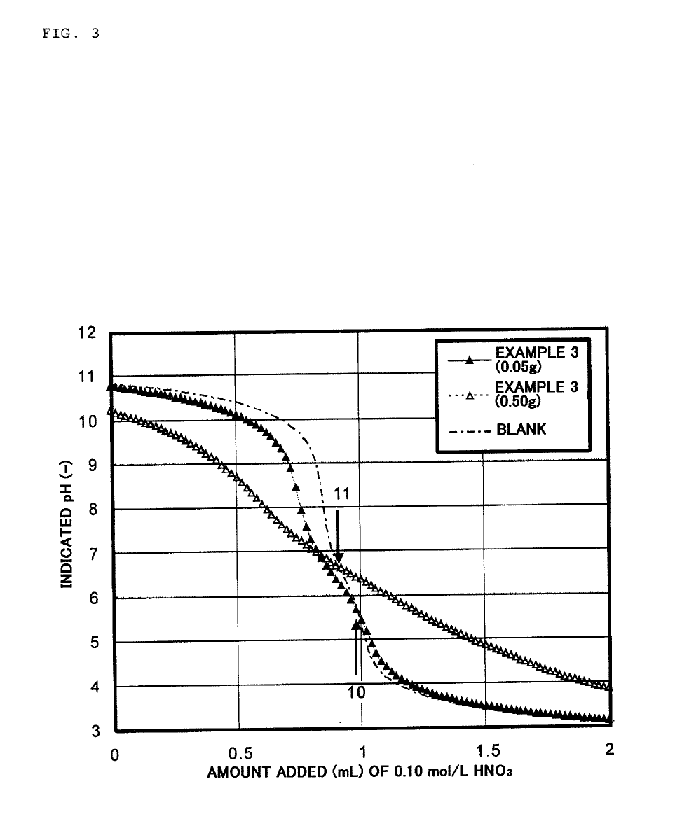

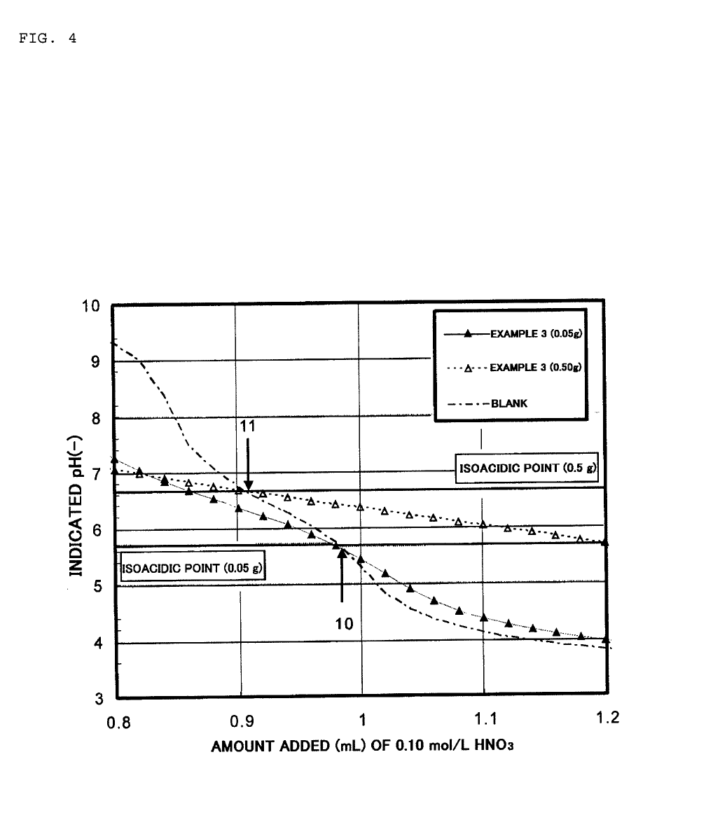

FIG. 3 shows an example of the results of measurement using the streaming potential automatic titrator 1. FIG. 4 is an enlarged graph of FIG. 3. These figures show the comparison between the titration curve obtained by using 0.05 g of a magnetic powder in Example 3 described later and the titration curve obtained by using 0.5 g of the magnetic powder. The horizontal axis represents the amount added of nitric acid (mL), and the vertical axis represents the pH observed. In the measurement, the magnetic powder used as a test powder is added to the potassium hydroxide solution, and the pH is recorded while the aqueous nitric acid solution was added, as described above. The pH of a reference line denoted by alternate long and short dash lines in the figures (no magnetic powder is contained) steeply changes from an alkaline side to an acidic side when the amount added of the aqueous nitric acid solution increases from 0.6 mL to 1.2 mL.

The titration curves represented by filled triangles and is open triangles show the behaviors of the change in pH when the magnetic powder was added. These behaviors are different from that in the reference. When 0.05 g of the magnetic powder was added (filled triangles), the behavior is close to that in the reference. However, the titration curve intersects the reference titration curve at a point near pH 5.9 (numeral 10).

When 0.5 g of the magnetic powder was added (open triangles), the behavior is gentler than that in the reference titration curve, and the titration curve intersects the reference titration curve at a point near pH 6.6 (numeral 11).

The amount of protons (H⁺) released/absorbed from/by the particles can be computed using the pH values measured in the presence or absence of the magnetic powder. More specifically, the computation is performed as follows. When the magnetic powder releases protons, the value of the amount of protons is negative (−). When the magnetic powder absorbs protons, the value of the amount of protons is positive (+). This can be described in terms of the value of pH. When protons are released from the magnetic particles, the pH takes a value on the acidic side of the reference (a smaller value). When protons are absorbed by the magnetic particles, the pH takes a value on the basic side of the reference (a larger value).

The amount of protons (H⁺) released/absorbed (stored) to/from the solution per unit area of the particles is computed using the following formula (I). In the formula (I), N_{A} is the Avogadro's number (=6.02×10²³). It goes without saying that, in the above computation, pH values obtained when equal amounts of nitric acid with a constant concentration were added are used for the comparison.

$${H}^{+} = \frac{\begin{matrix}( {10}^{- ( p H value in reference )} - {10}^{- ( p H value when sample was added )} ) \times \\ {N}_{A} ( 6.02 \times {10}^{23} )\end{matrix}}{\begin{matrix}( specific surface are ( {m}^{2} / g ) computed by BET method ) \times \\ ( weight ( g ) of sample used for measurement )\end{matrix}} \qquad ( 1 )$$

The amount of released/absorbed protons computed using the above formula represents the extent of donation/acceptance of protons caused by addition of the powder under circumstances in which equal amounts of protons were added to the solutions. Therefore, this value can be considered to represent the sensitivity of the powder to protons. For a powder subjected to conventional washing only, a large amount of protons were found to be released at a reference solution pH of 5. Although the detailed mechanism of this action is not known, it is assumed that acetic acid remaining on the powder has some action. Therefore, when the value is large (the particles release protons), these particles are very unpreferable for dispersion.

To find the above mechanism in a simpler manner, the following very simple method can be used. A pH 11 potassium hydroxide solution is prepared as a blank solution in advance. Then nitric acid with a concentration of 0.10 mol/L is added in an amount that changes the pH of 100 mL of the blank solution to 5 to a solution obtained by adding 0.05 g of a test powder to 100 mL of the blank solution, and then the pH value is checked. If the surface of the added powder is contaminated with an organic material, the pH of the solution containing the powder and being stirred becomes a value lower than 5 (a value on the acidic side). When the surface is clean, the pH is equal to or higher than 5. Therefore, the degree of cleanness of the surface can be checked only in this manner.

The blank solution used to determine the amount of nitric acid and the blank solution to which the sample powder is added are derived from the same blank solution. This is because preparation of different blank solutions with exactly the same pH=11 is not easy. “pH=11” means that the pH value is about 11 and more specifically in the range of pH=10.5 to 11.5.

### <Isoacidic Point of Particles>

As described above, the isoacidic point of particles is the point at which the release and absorption of protons is from/by the particles to/from the surrounding solution are balanced. More specifically, the isoacidic point is the pH value at the intersection between the reference titration curve and a titration curve when the powder is present. Generally, the value of the isoacidic point is not largely changed depending on the amount of the test powder. However, it was found that the value varies largely when the surface of particles is contaminated. For example, when the isoacidic point when 0.05 g was added is compared with the isoacidic point when 0.5 g was added, the smaller the difference in isoacidic point, the more preferred. More specifically, the difference is within ±1.5 and more preferably within ±1.0. For example, as shown in FIG. 3, the points of zero charge when the amounts of the magnetic powder are 0.05 g and 0.5 g are different, but the difference therebetween is within 1.0.

### EXAMPLES

Examples of the present invention and Comparative Examples will next be described. The chemical compositions used in Examples 1 to 3 and Comparative Examples 1 and 2 are shown in Table 1, and the physical properties, shape, surface properties, and isoacidic point of particles are shown in Table 2. The bulk properties of the magnetic powders and the properties of single-layer mediums produced are shown in Table 3.

### Example 1

162.04 g of iron oxide (HRT, a product of Tetsugen Corporation) and 289.69 g of barium carbonate (BW-P, a product of Sakai Chemical Industry Co., Ltd.) that were used as main constituent components were weighed. In addition, 89.47 g of boron oxide (industrial use, a product of Borax) used as a glass forming component was weighed, and 6.08 g of cobalt oxide (special grade reagent, a product of Wako Pure Chemical Industries, Ltd.), 6.48 g of titanium dioxide (special grade reagent, a product of Wako Pure Chemical Industries, Ltd.), 18.91 g of bismuth oxide (reagent, a product of KANTO CHEMICAL Co., Inc.), and 27.32 g of neodymium oxide (3N, a product of KISHIDA CHEMICAL Co., Ltd.) that were used as additives were weighed. In the above composition, the molar ratio of the rare-earth element to iron is 8%. In all the following Examples, preparation was performed such that the molar ratio of the rare-earth element to iron was 8%. Although the molar ratio of the rare-earth metal to iron before a preparation process was 8, the final ratio was 0.8. In Table 1, the molar ratio of the final powder is shown.

The obtained mixture was processed for 10 minutes using an automatic mortar such that a uniform mixture was obtained. The thus-obtained mixture was inserted into a platinum crucible, melted at 1,400° C., and maintained for 60 minutes to completely melt the mixture.

The obtained molten mixture was quenched using a double roller to pulverize the glass. The obtained glass was sieved with a 53 μm mesh to remove coarse particles, and the resultant powder was subjected to heat treatment at 650° C. for 1 hour.

The heat-treated powder was immersed in 10 mass % acetic acid heated to 60° C. and maintained for 60 minutes to remove the glass. Then acetic acid adhering to the surface of the powder was removed using pure water to obtain a ferrite magnetic powder. The ferrite magnetic powder was washed with 1.0 mol/L sodium hydroxide and then washed repeatedly with pure water until the conductivity of the filtrate became 0.8 mS/m or lower. The obtained powder was dried at 110° C. in air for 4 hours to obtain a magnetic powder. The physical properties of the obtained magnetic powder are shown in Table 2, and the magnetic properties of the magnetic powder are shown in Table 3.

### Example 2

The same procedure as in Example 1 was repeated except that the powder was washed using an alkali washing method to remove the glass and then washed repeatedly with pure water is until the conductivity of the filtrate became 0.8 mS/m or less. The physical properties of the obtained magnetic powder are shown in Table 2, and the magnetic properties of the magnetic powder are shown in Table 3.

### Example 3

The same procedure as in Example 1 was repeated except that the heat treatment temperature was changed to 670° C. and that the powder was washed using the alkali washing method to remove the glass and then washed repeatedly with pure water until the conductivity of the filtrate became 1.0 mS/m or less. The physical properties of the obtained magnetic powder are shown in Table 2, and the magnetic properties of the magnetic powder are shown in Table 3.

### Example 4

A magnetic powder was obtained by the same procedure as in Example 1 except that the temperature of the heat treatment of the glass was changed to 625° C. The physical properties of the obtained magnetic powder are shown in Table 2, and the magnetic properties of the magnetic powder are shown in Table 3.

### Examples 5 and 6

The same procedure as in Example 1 was repeated except is that the amount added of Nd which is a rare-earth element was changed. The physical properties of the obtained magnetic powders are shown in Table 2, and the magnetic properties of the magnetic powders are shown in Table 3.

### Examples 7 and 8

The same procedure as in Example 1 was repeated except that the amount of the ferrite used as a raw material was changed. In these Examples, the rare-earth element such as Nd was not used, but Nb as a group 5 element was added. The physical properties of the obtained magnetic powders are shown in Table 2, and the magnetic properties of the magnetic powders are shown in Table 3 (In Example 8, the amount added of Nb was larger than that in Example 7).

### Examples 9 to 12

In Examples 9 to 12, Ti and Co used in Example 7 were not added, and the amounts added of Bi and Nb were changed. The physical properties of the obtained magnetic powders are shown in Table 2, and the magnetic properties of the magnetic powders are shown in Table 3.

### Comparative Example 1

14.15 g of iron oxide (HRT, a product of Tetsugen Corporation) and 25.29 g of barium carbonate (BW-P, a product of Sakai Chemical Industry Co., Ltd.) that were used as main constituent components were weighed. In addition, 7.81 g of boron oxide (industrial use, a product of Borax) used as a glass forming component was weighed, and 0.53 g of cobalt oxide (special grade reagent, a product of Wako Pure Chemical Industries, Ltd.), 0.57 g of titanium dioxide (special grade reagent, a product of Wako Pure Chemical Industries, Ltd.), and 1.65 g of bismuth oxide (reagent, a product of KANTO CHEMICAL Co., Inc.) that were used as additives were weighed.

The obtained mixture was processed for 10 minutes using an automatic mortar such that a uniform mixture was obtained. The thus-obtained mixture was inserted into a platinum crucible, melted at 1,500° C., and maintained for 60 minutes to completely melt the mixture.

The obtained molten mixture was quenched using a double roller to pulverize the glass. The obtained glass was sieved with a 53 μm mesh to remove coarse particles, and the resultant powder was subjected to heat treatment at 690° C. for 1 hour.

The heat-treated powder was immersed in 10% diluted acetic acid heated to 60° C. to remove the glass. Then acetic acid adhering to the surface of the powder was removed using pure water to obtain a ferrite magnetic powder.

Then the ferrite magnetic powder was washed with pure water in an amount 250 times the weight of the magnetic powder, and the resultant powder was dried at 110° C. in air for four hours to obtain a magnetic powder.

### Comparative Example 2

A ferrite magnetic powder was obtained by the same procedure as in Example 1 except that the melting temperature was changed to 1,400° C. and the heat treatment temperature was changed to 640° C.

Therefore, in the ferrite magnetic powders in Comparative Examples 1 and 2, no rare-earth element is contained. The chemical compositions in Examples 1 to 12 and Comparative Examples 1 and 2 are shown in Table 1. The shapes of the powders and the surface properties thereof are shown in Table 2, and the magnetic properties of the powders and tapes formed using the same are shown in Table 3.

As can be seen from Table 2, the BET values of the magnetic powders in Examples 1 to 12 are higher than those in Comparative Examples 1 to 2. This is because the magnetic powders in the Examples contain a rare-earth element in their compositions and therefore sintering of adjacent particles was avoided.

The difference in dispersibility largely depends on the surface states of magnetic powders. The present invention proposes the method of evaluating the surface state using the powder pH and the isoacidic point. By linking them to the properties of a medium, the state of the particle surface can be grasped. More specifically, the powder pH values in Table 2 (“pH” values in the surface property column in the table) and the squareness ratios (SQx) of tapes formed by surface orientation (see Table 3) are first compared. The SQx values of the mediums in Examples 1 to 12 are 0.67 or higher. However, the SQx values of the mediums in Comparative Examples 1 and 2 are 0.65 or lower. When a coating is prepared and applied to a base film, its orientation properties are used as an index indicating the dispersibility of the magnetic coating. Therefore, it can be said that the magnetic powders in Example 1 to 12 can form coatings with high dispersibility.

The present inventors have made studies on the causes of the above properties and found that the above-described physical properties have large influences. This will be specifically described below. In each of the magnetic powders in the Comparative Examples, the powder pH was equal to or lower than 7, or the isoacidic point measured when 0.05 g of the magnetic powder was used was less than 5.

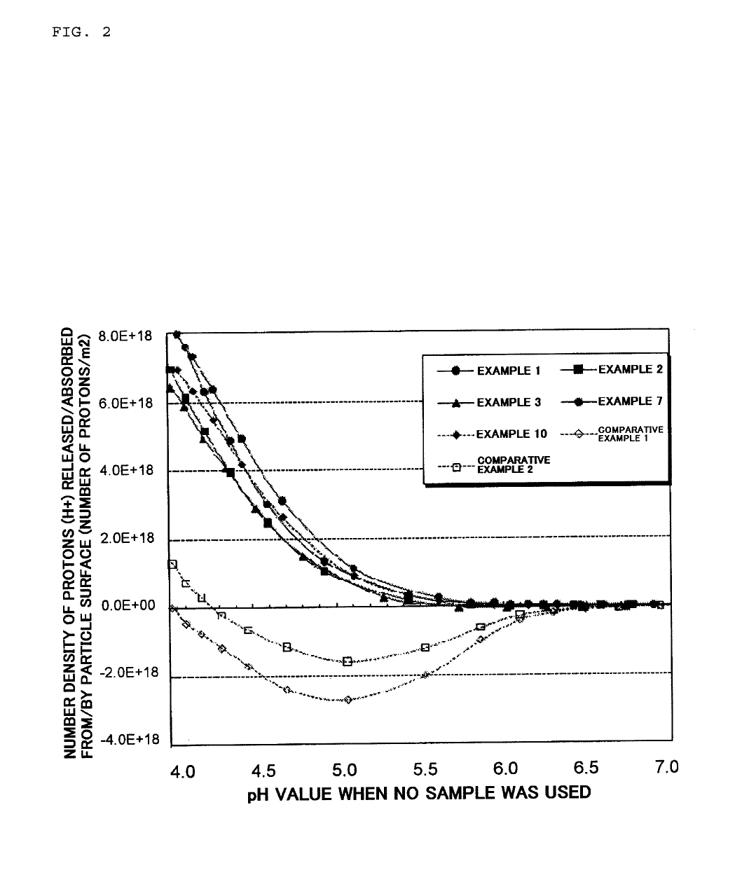

As can be seen from FIG. 2, the particles with an isoacidic point of less than 5 exhibit a property of absorbing protons when the powder is added to a blank solution with a pH of 5. This means that the surface of the powder is coated with a substance that can absorb protons for some reason and suggests the possibility that the surface is contaminated with foreign components.

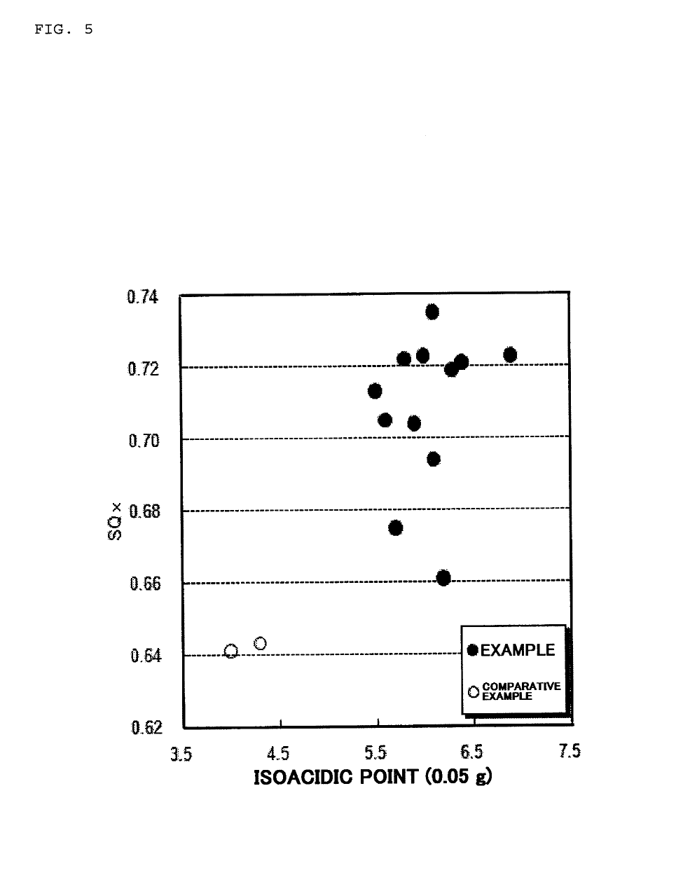

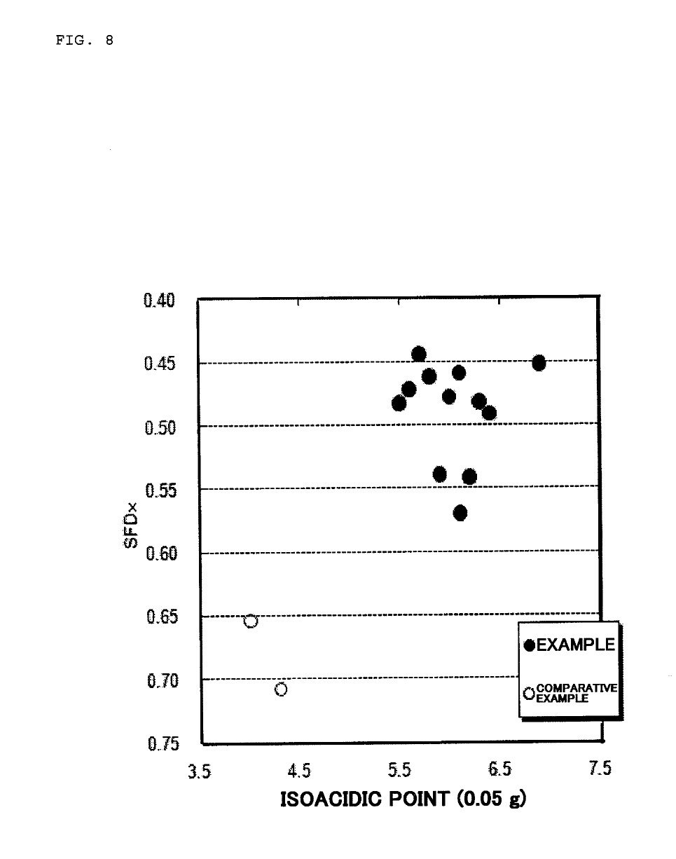

FIGS. 5 and 8 show the coercive force distributions of mediums and the SQ values versus the isoacidic point measured at 0.05 g. As can be seen from the figures, when the isoacidic point is 5 or higher, which means that the degree of contamination is small, good results are obtained. The contaminants evaluated are substances in a solution under stirring. Therefore, the evaluation is made for contaminant components that are not dissociated from and remain on the surface even under mechanical stirring.

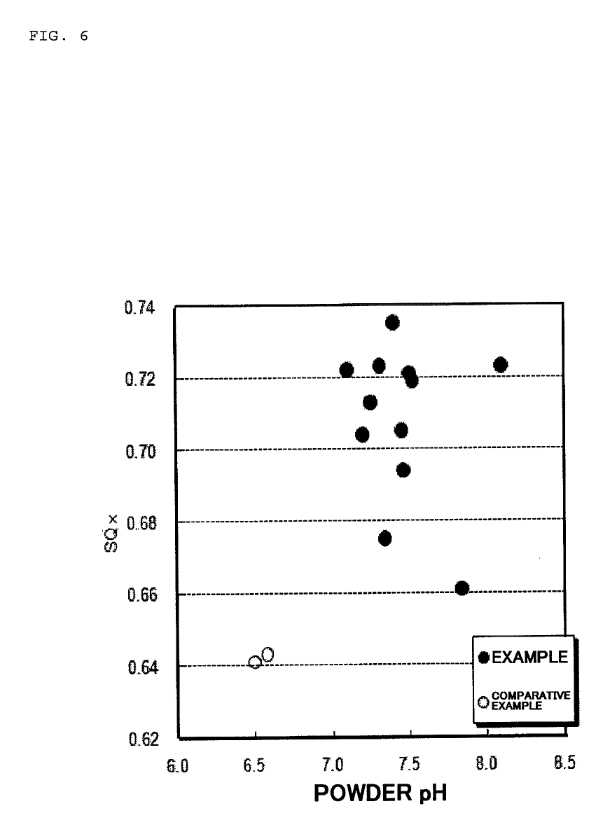

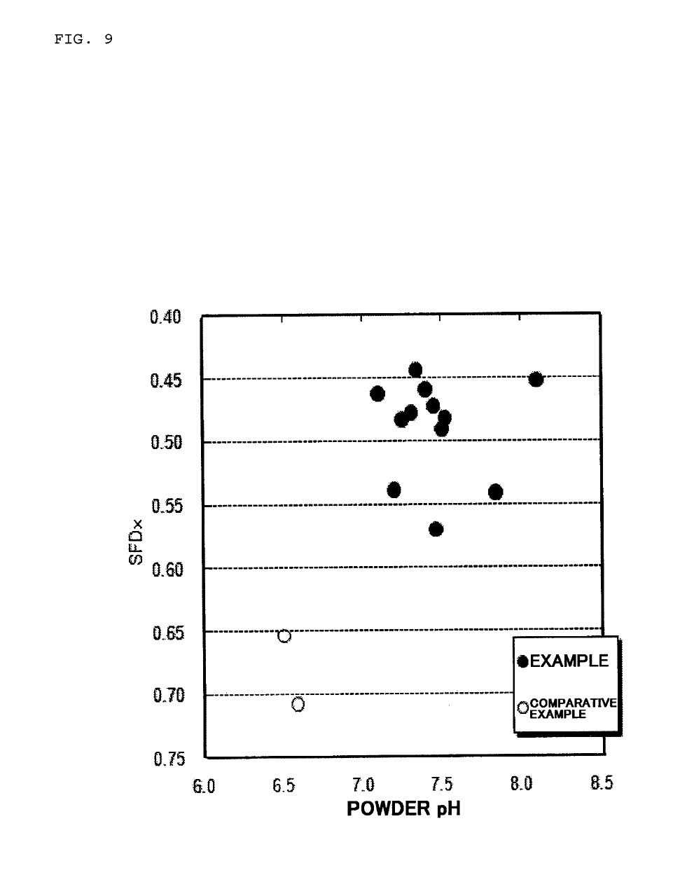

A similar tendency can be found when the powder pH is examined. As can be seen from the measurement method in which a pH value after boiling is measured, the powder pH results from components dissolved from particles or adhering to the particles. Therefore, contamination components that can be easily dissociated by hot water are evaluated from the above value. FIGS. 6 and 9 show the SQx values and coercive force distributions of mediums versus powder pH. As can be seen from these figures, when the powder pH is 7 or higher, which means that the degree of contamination is small, good values are obtained.

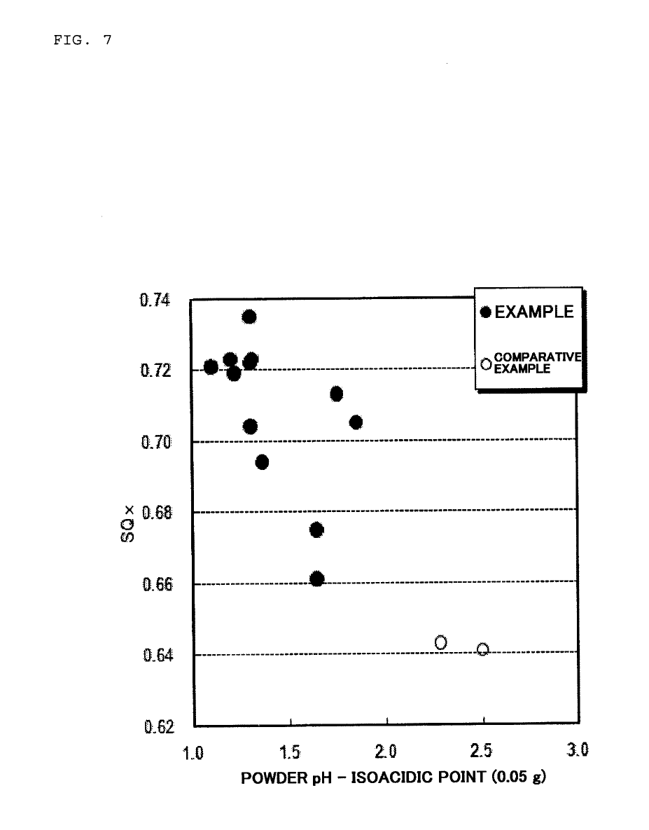

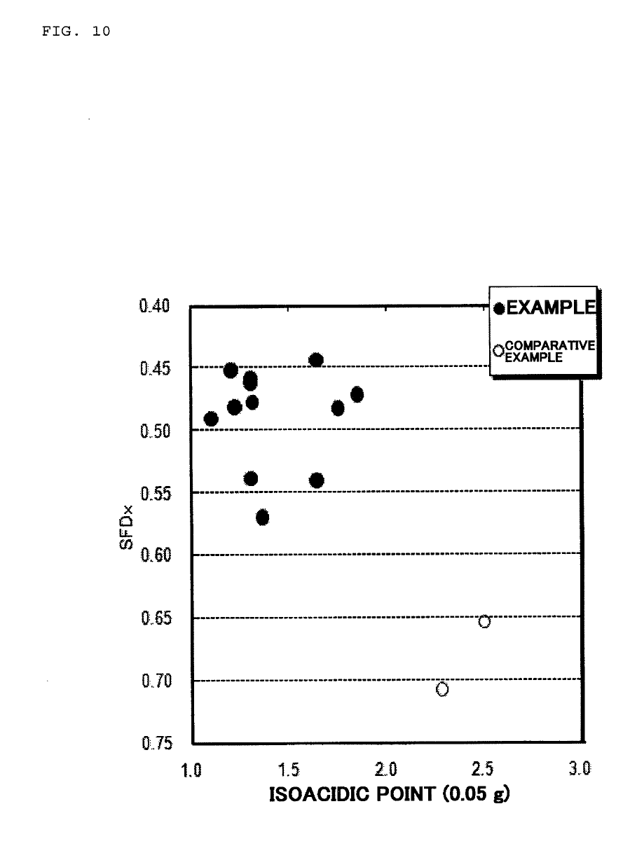

In any case, it may be desirable that the surface of particles be not coated with contaminants. More specifically, the comparison between these two evaluations shows that it is more preferable that the powder pH (the boiling method) and the isoacidic point be as close as possible. As shown in FIGS. 7 and 10, according to the above facts etc. obtained by the above-described medium evaluation methods, it was found that magnetic particles that cause the above difference (the difference between the powder pH and the isoacidic point) of less than 2.0 exhibit good dispersibility (squareness ratio).

TABLE 1

| | COMPOSITION | | | | | | | | |
|---|---|---|---|---|---|---|---|---|---|
| | (Fe + M)/2Ba | Co/Fe | Ti/Fe | Bi/Fe | Nd/Fe | Nb/Fe | B | sNa | sCa |
| | MOLAR RATIO | mol % | mol % | mol % | mol % | mol % | wt % | ppm | ppm |
| EXAMPLE 1 | 5.6 | 3.7 | 4.2 | 3.2 | 0.8 | — | 0.2 | 4 | 1 |
| EXAMPLE 2 | 5.6 | 3.7 | 4.2 | 3.2 | 0.8 | — | 0.2 | 7 | 2 |
| EXAMPLE 3 | 5.6 | 3.7 | 4.2 | 3.2 | 0.8 | — | 0.2 | 13 | 5 |
| EXAMPLE 4 | 5.6 | 3.7 | 4.2 | 3.2 | 0.8 | — | 0.2 | 5 | 2 |
| EXAMPLE 5 | 5.6 | 3.7 | 4.2 | 3.2 | 0.3 | — | 0.4 | 8 | 4 |
| EXAMPLE 6 | 5.6 | 3.7 | 4.2 | 3.2 | 1.0 | — | 0.2 | 10 | 3 |
| EXAMPLE 7 | 5.6 | 2.3 | 2.3 | 0.1 | — | 1.8 | 0.2 | 8 | 5 |
| EXAMPLE 8 | 5.4 | 2.0 | 2.0 | 0.1 | — | 2.2 | 0.3 | 7 | 5 |
| EXAMPLE 9 | 5.6 | — | — | 3.2 | — | 1.6 | 0.4 | 5 | 2 |
| EXAMPLE 10 | 5.6 | — | — | 3.2 | — | 1.0 | 0.2 | 7 | 5 |
| EXAMPLE 11 | 5.4 | — | — | 2.0 | — | 1.4 | 0.2 | 6 | 2 |
| EXAMPLE 12 | 5.4 | — | — | 2.0 | — | 0.8 | 0.3 | 3 | 3 |
| COMPARATIVE | 5.7 | 3.6 | 4.0 | 2.4 | — | — | 0.1 | 7 | 6 |
| EXAMPLE 1 | | | | | | | | | |
| COMPARATIVE | 5.8 | 3.7 | 4.2 | 3.2 | — | — | 0.2 | 27 | 6 |
| EXAMPLE 2 | | | | | | | | | |

In Table 1, “(Fe+M)/2Ba” represents the molar ratio of metal elements including iron to barium. For each of Co, Ti, Bi, Nd, and Nb, the molar ratio of the element to iron (Fe) is shown. Each of “sNa” and “sCa” represents the amount of a water-soluble component dissolved in water when 1 g of a test powder is added to 100 mL of pure water and the mixture is left to stand for 10 minutes. sNa represents the amount of water soluble sodium, and sCa represents the amount of water soluble calcium.

TABLE 2

| | PROPERTIES | | | | SURFACE | | | ISOACIDIC POINT | | |
|---|---|---|---|---|---|---|---|---|---|---|
| | OF PARTICLES | | SHAPE | | PROPERTIES | | | | | DIFFER- |
| | PLATE DIA. | VOLUME | BET | TAP | | StA | | 0.05 g | 0.5 g | ENCE |
| | nm | nm³ | m²/g | g/cc | pH | mg/g | mg/m² | — | — | — |
| EXAMPLE 1 | 21 | 1765 | 88.7 | 1.2 | 8.10 | 117 | 1.31 | 6.9 | 7.4 | 0.5 |
| EXAMPLE 2 | 21 | 1690 | 85.2 | 1.1 | 7.40 | 113 | 1.32 | 6.1 | 6.8 | 0.7 |
| EXAMPLE 3 | 22 | 1950 | 72.1 | 1.1 | 7.34 | 91.8 | 1.27 | 5.7 | 6.6 | 0.9 |
| EXAMPLE 4 | 22 | 1945 | 93.4 | 1.3 | 7.10 | 117 | 1.25 | 5.8 | 6.9 | 1.1 |
| EXAMPLE 5 | 24 | 2650 | 75.2 | 1.3 | 7.45 | 103 | 1.38 | 5.6 | 6.7 | 1.1 |
| EXAMPLE 6 | 20 | 1625 | 90.1 | 1.2 | 7.25 | 109 | 1.21 | 5.5 | 6.5 | 1.0 |
| EXAMPLE 7 | 24 | 2520 | 66.2 | 1.1 | 7.46 | 109 | 1.65 | 6.1 | 7.0 | 0.9 |
| EXAMPLE 8 | 22 | 2250 | 60.3 | 1.5 | 7.50 | 97.2 | 1.61 | 6.4 | 7.5 | 1.1 |
| EXAMPLE 9 | 20 | 1650 | 65.7 | 1.2 | 7.20 | 101 | 1.53 | 5.9 | 6.9 | 1.0 |
| EXAMPLE 10 | 19 | 1525 | 64.1 | 1.4 | 7.84 | 93.6 | 1.46 | 6.2 | 7.2 | 1.0 |
| EXAMPLE 11 | 23 | 2320 | 67.9 | 1.2 | 7.31 | 103 | 1.52 | 6.0 | 6.8 | 0.8 |
| EXAMPLE 12 | 21 | 2230 | 63.2 | 1.3 | 7.52 | 99.3 | 1.57 | 6.3 | 7.1 | 0.8 |
| COMPARATIVE | 25 | 4050 | 47.7 | 1.1 | 6.50 | 63.7 | 1.34 | 4.0 | 5.5 | 1.5 |
| EXAMPLE 1 | | | | | | | | | | |
| COMPARATIVE | 21 | 2400 | 58.5 | 1.2 | 6.58 | 90.5 | 1.55 | 4.3 | 6.0 | 1.7 |
| EXAMPLE 2 | | | | | | | | | | |

In Table 2, “plate diameter” represents the average plate diameter of particles, “volume” represents the “particle volume,” “BET” represents the specific surface area, “TAP” represents the tap density, and “StA” represents the amount of stearic acid adsorbed on particles (mg/g). The amount of stearic acid per unit area (mg/m²) computed from the BET (m²/g) is also shown.

TABLE 3

| | | | | | | | PROPERTIES OF SINGLE-LAYER | | | | | | |
|---|---|---|---|---|---|---|---|---|---|---|---|---|---|
| | | | | | | | MEDIUM (IN-PLANE ORIENTATION) | | | | | | |
| | BULK PROPERTIES | | | | | | | | SINGLE- | | | | |
| | Hc | | Hc/V | σs | | | Hc | | LAYER/BULK | | | | |
| | Oe | kA/m | Oe/nm³ | emu/g | SQ | BSFD | Oe | kA/m | % | SFD | SQx | OR | SQz |
| EXAMPLE 1 | 2155 | 171.5 | 1.22 | 46.3 | 0.501 | 0.734 | 2527 | 201.1 | 117.3 | 0.452 | 0.723 | 1.88 | 0.429 |
| EXAMPLE 2 | 2176 | 173.2 | 1.29 | 45.9 | 0.503 | 0.727 | 2539 | 202.0 | 116.7 | 0.459 | 0.735 | 1.94 | 0.426 |
| EXAMPLE 3 | 2535 | 201.7 | 1.30 | 45.3 | 0.514 | 0.644 | 2833 | 225.4 | 111.8 | 0.444 | 0.675 | 1.56 | 0.441 |
| EXAMPLE 4 | 2422 | 192.7 | 1.25 | 45.3 | 0.516 | 0.711 | 2793 | 222.3 | 115.3 | 0.462 | 0.722 | 1.92 | 0.429 |
| EXAMPLE 5 | 2450 | 195.0 | 0.92 | 42.8 | 0.507 | 0.704 | 2619 | 208.4 | 106.9 | 0.472 | 0.705 | 1.63 | 0.462 |
| EXAMPLE 6 | 2625 | 208.9 | 1.62 | 44.6 | 0.501 | 0.844 | 2814 | 223.9 | 107.2 | 0.483 | 0.713 | 1.57 | 0.443 |
| EXAMPLE 7 | 2403 | 191.2 | 0.95 | 48.8 | 0.507 | 0.867 | 2781 | 221.3 | 115.7 | 0.570 | 0.694 | 1.61 | 0.442 |
| EXAMPLE 8 | 2225 | 177.1 | 0.99 | 45.3 | 0.515 | 0.829 | 2429 | 193.3 | 109.2 | 0.491 | 0.721 | 1.52 | 0.429 |
| EXAMPLE 9 | 2720 | 216.5 | 1.65 | 43.4 | 0.521 | 0.843 | 3053 | 243.0 | 112.2 | 0.539 | 0.704 | 1.62 | 0.453 |
| EXAMPLE 10 | 2746 | 218.5 | 1.80 | 44.1 | 0.520 | 0.853 | 3127 | 248.8 | 113.9 | 0.541 | 0.661 | 1.46 | 0.473 |
| EXAMPLE 11 | 2628 | 209.1 | 1.13 | 43.8 | 0.514 | 0.821 | 2729 | 217.2 | 103.8 | 0.478 | 0.723 | 1.42 | 0.472 |
| EXAMPLE 12 | 2428 | 193.2 | 1.09 | 42.7 | 0.517 | 0.842 | 2573 | 204.8 | 106.0 | 0.482 | 0.719 | 1.45 | 0.469 |
| COMPARATIVE | 2825 | 224.8 | 0.70 | 48.1 | 0.512 | 0.909 | 3099 | 246.6 | 109.7 | 0.654 | 0.641 | 1.41 | 0.446 |
| EXAMPLE 1 | | | | | | | | | | | | | |
| COMPARATIVE | 2370 | 188.6 | 0.99 | 45.1 | 0.491 | 1.100 | 2697 | 214.6 | 113.8 | 0.708 | 0.643 | 1.54 | 0.410 |
| EXAMPLE 2 | | | | | | | | | | | | | |

In Table 3, “single layer/bulk” represents the ratio of the Hc in the bulk properties to the Hc in the single-layer medium properties.

### INDUSTRIAL APPLICABILITY

The present invention can be preferably used for a magnetic powder for high-density magnetic recording mediums.

### REFERENCE SIGNS LIST

1 streaming potential automatic titrator
2 tank
3 electrometer (pH meter)
4 titrator
5 introduction tube for nitrogen gas
6 magnetic stirrer
7 stirring chip
8 line of magnetic force
10 isoacidic point when 0.5 g is added
11 isoacidic point when 0.05 g is added

1. A hexagonal ferrite magnetic powder, wherein, when 0.10 mol/L nitric acid is added in an amount that changes a pH of 100 mL of a pH 11 potassium hydroxide solution used as a blank solution to 5 to a solution prepared by adding 0.05 g of the hexagonal ferrite magnetic powder to 100 mL of the blank solution, a value of pH of the resultant solution is 5 or higher.

2. A hexagonal ferrite magnetic powder wherein, when 0.10 mol/L nitric acid is added in an amount that changes a pH of 100 mL of a pH 11 potassium hydroxide solution used as a blank solution to 5 to a solution prepared by adding 0.05 g of the hexagonal ferrite magnetic powder to 100 mL of the blank solution, a computed amount of protons (H⁺) released is equal to or larger than 0.

3. The hexagonal ferrite magnetic powder according to claim 1, wherein a difference between an isoacidic point computed using 0.05 g of the hexagonal ferrite magnetic powder and an isoacidic point computed using 0.5 g of the hexagonal ferrite magnetic powder is less than ±1.5.

4. The hexagonal ferrite magnetic powder according to claim 1, including particles having a powder pH of 7.0 or higher that is computed by a boiling method described in JIS standard K-5101-17-1:2004.

5. The hexagonal ferrite magnetic powder according to claim 1, having an average plate diameter of 5 to 50 nm and a specific surface area of 50 m²/g or higher as measured by a BET method.

6. A magnetic recording medium using the magnetic powder according to claim 1.
